(19) United States
(12) Patent Application Publication
(10) Pub. No.: US 2026/0277733 A1
(43) Pub. Date: Sep. 17, 2026

(54) GENERATIVE ARTIFICIAL INTELLIGENCE INCIDENT RESPONSE AND MANAGEMENT SYSTEM

(71) Applicant: NVIDIA Corporation, Santa Clara, CA (US)

(72) Inventors: Tanner Leach, West Palm Beach, FL (US); Charles MacKay, Newark, CA (US); Rama Akkiraju, Cupertino, CA (US); Seema Phalke, San Jose, CA (US); Amreth Chandrasehar, Newark, CA (US); Hridhay Mehta, San Jose, CA (US)

(21) Appl. No.: 19/235,880

(22) Filed: Jun. 12, 2025

Related U.S. Application Data
(60) Provisional application No. 63/771,869, filed on Mar. 14, 2025.

(51) Int. Cl. G06F 11/07

(52) U.S. Cl. CPC G06F 11/0793; G06F 11/0751; G06F 11/2252

(57) ABSTRACT

Disclosed are apparatuses, systems, and methods, for generative artificial intelligence incident response and management of IT systems. The systems and methods may, based on real time identification of an incident using event data from one or more event data resources of a plurality of event data resources, identify a plurality of entities associated with the one or more event data resources to address the incident in real time. The system may then provide a potential solution for resolving the incident to the plurality of entities on a generated communication channel. By monitoring one or more entity actions associated with the incident, the system and methods may provide an updated potential solution to address the incident in real time based on the one or more entity actions, event data from the one or more data resources, and historical incident data from the plurality of historical incidents associated with the incident.

### RELATED APPLICATION

This application claims the benefit of U.S. Provisional Application No. 63/771,869, filed on Mar. 14, 2025, the entire content of which are hereby incorporated by reference herein.

### BACKGROUND

An information technology (IT) infrastructure can be a complex and multicomponent system. An IT infrastructure can include a plurality of data resources including, for example, networks, hardware, virtual machines, software, and the like. For full functionality of the IT infrastructure, all data resources must be operating correctly. Failure of even a single data resource can cause issues within the system from a simple, singular device functionality loss to full IT infrastructure blackouts.

### BRIEF DESCRIPTION OF THE DRAWINGS

FIG. 1 is a schematic block diagram of an example system architecture providing generative artificial intelligence incident response and management of IT systems, according to at least one embodiment;

FIG. 2 is an expanded view of the schematic block diagram of an example system architecture providing generative artificial intelligence incident response and management of IT systems of FIG. 1, according to at least one embodiment;

FIG. 3 a flow diagram for generating and updating communication channels for an incident on the architecture providing generative artificial intelligence incident response and management of IT systems of FIG. 2, according to at least one embodiment;

FIG. 4 is a schematic block diagram of a map of event data resources of an IT system, according to at least one embodiment;

FIG. 5 is a flow diagram of an example method of generative artificial intelligence incident response and management of IT systems, according to at least one embodiment;

FIG. 6A illustrates inference and/or training logic, according to at least one embodiment;

FIG. 6B illustrates inference and/or training logic, according to at least one embodiment;

FIG. 7 illustrates training and deployment of a neural network, according to at least one embodiment;

FIG. 8 is an example data flow diagram for an advanced computing pipeline, according to at least one embodiment;

FIG. 9 is a system diagram for an example system for training, adapting, instantiating, and deploying machine learning models in an advanced computing pipeline, according to at least one embodiment;

FIG. 10A is a block diagram of an example generative language model system suitable for use in implementing at least some embodiments of the present disclosure;

FIG. 10B is a block diagram of an example embodiment in which the generative LM includes a transformer encoder-decoder, according to at least one embodiment;

FIG. 10C is a block diagram of an example embodiment in which the generative LM includes a decoder-only transformer architecture, according to at least one embodiment; and

FIG. 11 is a block diagram of an example computing device suitable for use in implementing some embodiments of the present disclosure.

### DETAILED DESCRIPTION

Diagnosing and troubleshooting failures in traditional systems has been difficult as administrative users, such as IT technicians, have been required to manually review each component to identify the problem components and root causes of issues. Existing systems may store data for each component and, upon indication of an issue, administrative users may access and pull any data they deem is applicable to the current issue. Depending on the issue, timely diagnosis and recourse is required. An issue that includes widespread problems may be escalated to be considered an incident. An incident may require accelerated resolution to fix the issues plaguing many aspects of the IT infrastructure functionality.

Additionally, in traditional systems, regular system health checks may require administrative users to conduct manual health checks on each component within the system. Depending on the complexity of the IT infrastructure, regular system health checks may be impractical, as manual checks may be time consuming and a limited number of administrative users may be devoted to the task.

A generative artificial intelligence (AI) incident messaging and management system may be used to perform real-time and near real-time analysis and diagnostics to aid administrative users in monitoring health of the system and resolving issues and incidents. In some embodiments, the generative AI incident response and management system (e.g., the system) may be used to monitor the health of the IT infrastructure and all data resources within. In some embodiments the system may receive a request, for example from a user, to provide a health update to the user. In some embodiments, the request may be received in plain language from the user. For example, the request may be a typed question or statement, an audio recording of a voice request, or the like. A request may be, for example, “What is the status of each server in the server room?” Upon receiving the request, the system may generate a communication channel that can be used for the user to input additional information, or for the system to supply responses or prompts for information to the user.

In some embodiments, the request may be received and authenticated as a valid request. Upon authentication, the request may be provided to an AI model to interpret the plain language of the request into language usable by the system. For example, the AI model may be a large language model (LLM) or other generative model type (e.g., VLM, MMLM) that can be provided natural language (and/or other input types, such as audio, image, sensor, and/or other data types) from a user and can interpret the natural language for use within the system. The AI model may be further used to generate responses or requests for information from the user. The processed request may be used to select an agent within the system to query one or more event data stores. For example, a user may input a request “What is the status of each server in the server room?” An AI model may be used to understand that the user is looking for a current operating state or “status” of servers in a specific location. In some IT infrastructures, multiple server rooms may be in use. To ascertain the room the user is indicating, the system may utilize the communication channel to request additional information. The AI model may generate a prompt for additional information such as “Please indicate which server room.” Upon receiving an indication of the server room, the system may have enough information to generate a query.

In some embodiments, one or more event data stores may store event data for events that occur within data resources of the IT infrastructure. Agents may be utilized to access the databases, wherein each agent may be configured to interact with a specific database. Continuing the example from above, the agent may be selected as the agent that is configured to interact with an event data store containing event data for the servers. The query may be used to pull data related to the servers in the identified room and the results may be interpreted and converted into plain language that can be provided to the user.

In some embodiments, the generative AI incident response and management system can be used to monitor data resources within the IT infrastructure to identify issues. An issue may be identified using, for example, data from data resources during regular monitoring or can be identified after processing the request from the user. Data resources can be, for example, IT assets, alerts, and the like. Based on event data from one or more of the data resources, the generative AI incident response and management system at an event monitor monitoring the data resources for event data may determine if an issue, or one or more issues, rise to the level of an incident. An incident may be any problem that is occurring and/or has occurred within the system that requires immediate attention. For example, an issue may be an inability of a singular user device to connect to a network, whereas an incident may be an inability of all user devices within a geographical region to connect to a network.

Once an incident is identified, the system may generate communication channels, using, for example, collaboration tools, to enable immediate interaction of administrative users. The system may identify users that may have ownership over the incident. For example, within an administrative user team, administrative users may be tasked with various portions of the IT infrastructure to monitor and troubleshoot. Portions may be individual assets, alarm types, event types, geographical regions, or the like. Depending on the data indicating concerns at the various portions of the IT infrastructure, different administrative users may be required to troubleshoot the issue. The administrative users associated with the incident may be provided access to the communication channel.

The system may access a historical data store to identify historical incidents that may have a high relevance to the incident. Historical data may include, event data, communication channel data, resolution data, and/or the like collected during a past incident. Relevance to the incident may be utilized to determine the if the historical data may be beneficial in understanding the current incident. Sufficiently relevant historical data may be used to generate proposed solutions for the incident.

In some embodiments, to generate a potential solution, the system may analyze data from the event data stores. To properly query the event data stores, the system may utilize the selector, as described above, to connect with, and generate a command for, an event data store to retrieve the event data. Using the event data from the event data stores and the historical data, the system may generate a proposed solution to be provided to the administrative users. The AI model may be used to translate the proposed solution into plain language understandable by the administrative users. The system may then provide the proposed solution, for example, within the communication channel.

In some embodiments, after an incident has been identified and prior to a resolution to the incident, the system may provide updated proposed solutions to the administrative users. For example, after the communication channel has been generated, the system can monitor the channel for additional information provided by the administrative users. Additional information can be, for example, resolution attempts, results of visual inspections, and the like. Using the additional information from the communication channel and event data generated after the identification of the incident, the system may generate an updated proposed solution. Additionally, the summary updates may be generated based on the additional information and the event data and provided to administrators, for example, to supervisors.

Upon resolution of the incident, the system may generate an incident history to be stored in the historical data database for us identifying and resolving future incidents. Additionally, a summary of the resolution of the incident can be generated and provided to administrators, for example, supervisors.

Applications and methods herein can enable faster real time and near real time incident identification and resolution by monitoring event data to identify an incident and enabling communication of entities associated with the incident. Enabling the communication to relevant entities and monitoring entity actions to generate solutions and for use in future incident resolution proposals can aid in timely resolution of the incident.

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice-such an inference microservice (e.g., NVIDIA NIMs)-which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications-such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

In some embodiments, one or more transformer engines (TEs) may be implemented. The transformer engine may use micro-tensor scaling to optimize performance and accuracy-such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices-such as GPUs-to provide better performance with lower memory utilization in both training and inference. When the TE is combined with other technologies, such as high-speed interconnects between nodes (e.g., using switches-such as NVLink Switches) and tensor cores (which enable mixed-precision computing, such as microscaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

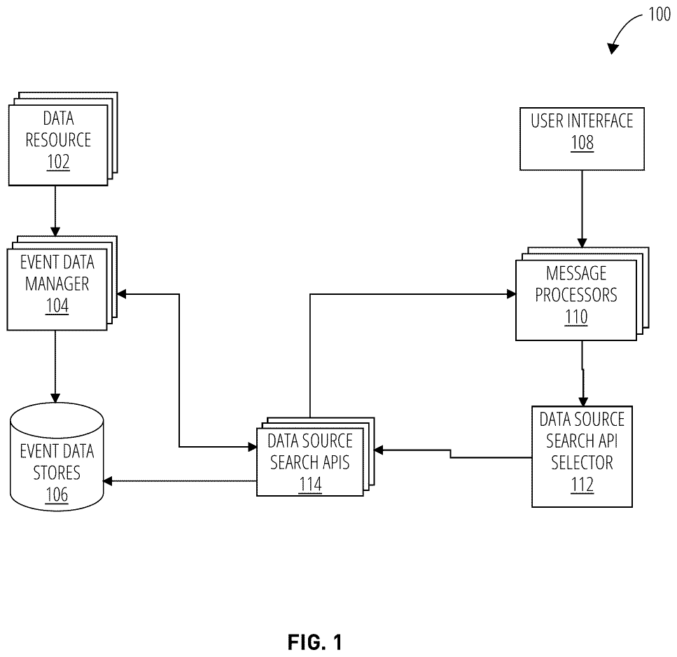

FIG. 1 is a schematic block diagram of an example system 100 architecture providing generative artificial intelligence incident response and management of IT systems, according to at least one embodiment. The generative artificial intelligence incident response and management of IT systems can be performed using a system such as the system architecture 100 of FIG. 1. The system may include one or more data resource 102. In some embodiments, the event data resource 102 may be data sources within an information technology (IT) system that produce data. For example, a data source can be a hardware asset, a software asset, a network asset, a data asset, an intangible asset, a cloud asset, storage devices, an alert, a log, monitoring tools, and the like. The data resource 102 may provide the event data to an event data manager 104.

In some embodiments, the event data manager 104 can receive data and analyze the data to identify problems that may be occurring within the system 100. A problem may be an isolated issue or may rise to a level of an incident which may be a concern that requires immediate attention. The event data manager 104 may determine, based on real-time and near real-time data from the data resource 102, that there is an incident that needs to be addressed.

In some embodiments, the event data manager 104 may process all the data from the data resource 102 to provide the event data to the proper event data stores 106. In some embodiments, different event data stores 106 can be used to provide efficient data queries. The event data manager 104 may be used to sort the event data into the appropriate event data stores 106.

Event data may be stored in the event data stores 106 for access. In some embodiments, access may occur in response to a request by a user. The request may be received at a user interface 108 which may provide the request to one or more message processors 110. The message processor 110 may interpret the request from the user from plain language into text usable by the system 100. For example, the user may provide the request, “What is the temperature for each server in server room 7.” The message processor 110 may, convert the request into a query usable by the system that looks for data associated with ‘temperature’, ‘servers’, and ‘sever room 7’. The message processor 110 may generate a query for querying data stores.

In some embodiments, the query can be provided to the data source search application programming interface (API) selector 112. The data source search API selector 112 may use the query and system 100 information to determine which event data stores 106 to query. For example, a data store 106 may be a data store associated with ‘server room 7’, the data source search API selector 112 may generate a query to obtain event data associated with ‘temperatures’ of ‘servers’ from the appropriate data store.

In some embodiments, the data source search APIs 114 may receive an indication of the event data store 106 to search based on the event data store 106 identified by the data source search API selector 112. The data source search APIs 114 may then return data and/or a generated query response to the message processor 110 for a response to be provided to the user. In some embodiments the response is generated based on the automatic incident identification using the event data manager 104 and is provided to one or more users after being converted into plain language by the message processors 110.

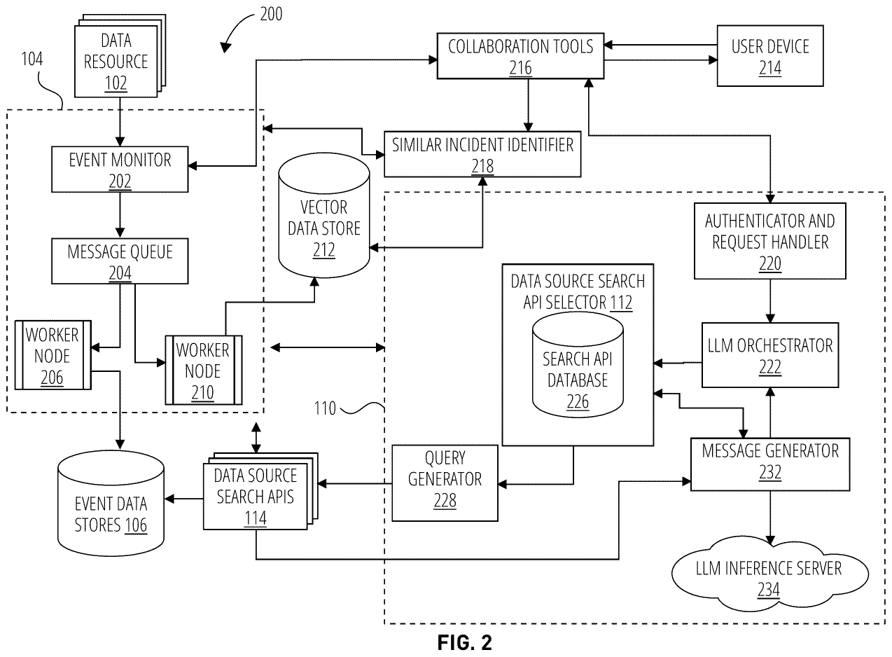

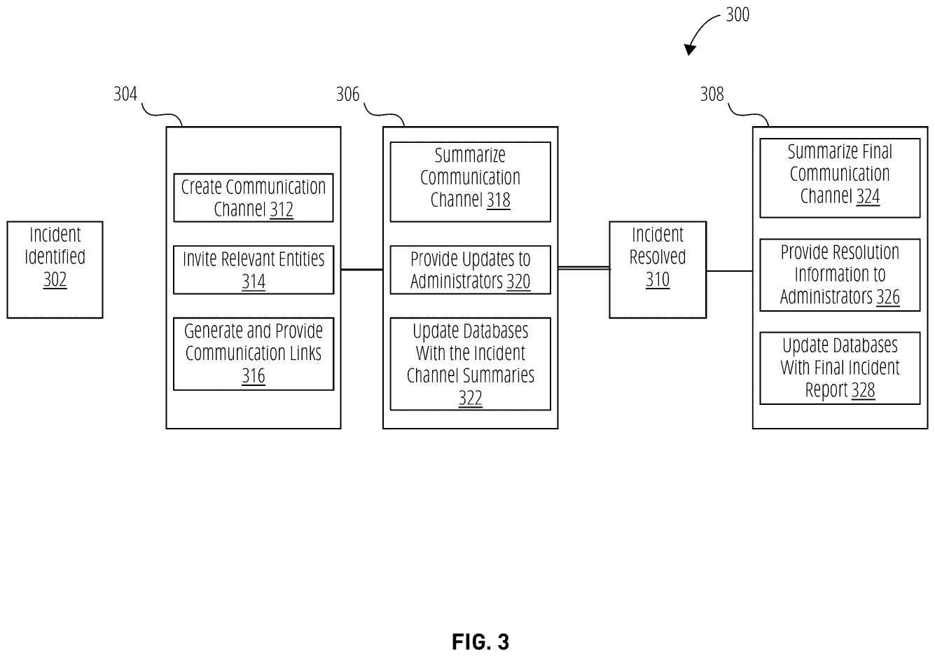

In some embodiments, as discussed in detail in FIGS. 2-3 below, the incident, prompts, and responses provide to and received from the user can be communicated to the user in a generated communication channel. The communication channel can be used to communicate the data, provide notice for incidents, and the like.

FIG. 2 is an expanded view system architecture 200 of the schematic block diagram of an example system architecture providing generative artificial intelligence incident response and management of IT systems of FIG. 1, according to at least one embodiment. As discussed above, the system may include one or more data resource 102. In some embodiments, the event data resource 102 may be data sources within an information technology (IT) system that produce data. For example, a data source can be a hardware asset, a software asset, a network asset, a data asset, an intangible asset, a cloud asset, storage devices, an alert, a log, monitoring tools, and the like. The data resource 102 may provide the event data to an event data manager 104.

The event data manager 104 may include an event monitor 202, a message queue 204, a worker node 206 and 210. Each data resource 102 may be connected to a dedicated event data manager 104. The event monitor 202 may receive and analyze event data from the data resource 102. In some embodiments, the event monitor 202 may be configured with parameters for each type of event data. For example, a parameter for temperature of a server may be a threshold value. Upon receiving event data that indicates the temperature of the server has exceeded the threshold value, the event monitor 202 may determine an incident has occurred. In some embodiments, the event monitor 202 may be a machine learning model configured to analyze data based on information in the event data stores 106.

In some embodiments, the event monitor 202 may provide the event data to one or more message queues 204. The message queues 204 may store data awaiting data processing by a worker node 206 and 210. Worker nodes 206 and 210 may be responsible for processing event data by executing specific tasks based on the event type. In some embodiments processing event data may include transforming the data into a desired format, applying business logic, or triggering actions like updating databases, and the like. Once the event is processed, the worker nodes 206 and 210 may store the data in a data store such as event data stores 106 and/or vector data store 212 or forward it to another service for further handling.

In some embodiments, the event monitor 202 may determine there is no incident indicated by the event data. The event data may then be provided to the message queue 204 associated with the worker node 206 for data processing. In some embodiments, the event monitor 202 may determine there is an incident indicated by the event data or that the event data is associated with an ongoing incident and may provide the event data to a message queue 204 associated with the worker node 206 to be stored in the vector data store 212 along with the other incident data associated with the incident. In some embodiments, the event monitor 202 may provide the event data such that it can be processed by both worker nodes 206 and 210. Processed event data may be stored in the event data stores 106 and the vector data store 212.

Upon identification of an incident, the event data manager 104, for example at the event monitor 202, may provide an update and/or the event data to the similar incident identifier 218. The similar incident identifier 218 may generate a query based on the information from the event data manager 104 to query the vector data store 212 for data for historical incidents that are related to the incident. The past incidents may be selected from the vector data store 212 by the similar incident identifier 218 based on a relevancy confidence of the historical incident data satisfies a threshold. The relevancy confidence may indicate a relevancy of the historical incident data to the incident. The similar incident identifier 218 may review the data and compare it to the incident to determine a relevancy of the historical incident data to the incident. Based on the relevancy meeting a threshold, the similar incident identifier 218 may provide the relevant data, such as solutions tried and not tried, to the event data manager 104 to aid in generation of a potential solution.

In some embodiments, upon identification of an incident, the event data manager 104, for example at the event monitor 202, may provide information to the collaboration tools 216. The collaboration tools 216 may generate a communication channel that may connect one or more entities to address the incident. In some embodiments, the communication channel may be a video conference call, a chat window, an email chain, and the like that enables communication between entities. In some embodiments, entities may be technicians, engineers, administrators, and the like that have been identified as being associated with the data resources 102 affected by the incident. To determine the entities to be included in the communication channel, the event data manager 104 may provide incident information to the data source search APIs 114.

In some embodiments, the event data manager 104 may provide data requests to the message processor 110. The message processor 110 may include a data source search API selector 112. The data source search API selector 112 may be provided keywords, information, data, and the like and may utilize a search API database 226 to identify one or more data source search APIs 114 to use. For example, an incident may occur at a server and may be identified using temperature data. The data source search API selector 112 may receive the information, determine a first data source search API 114 associated with a first event data store 106 that includes temperature data for the server. The data source search API selector 112 may then provide the event data manager 104 with the data source search API 114 to gather the desired event data or may generate a query for the data source search API 114 using a query generator 228.

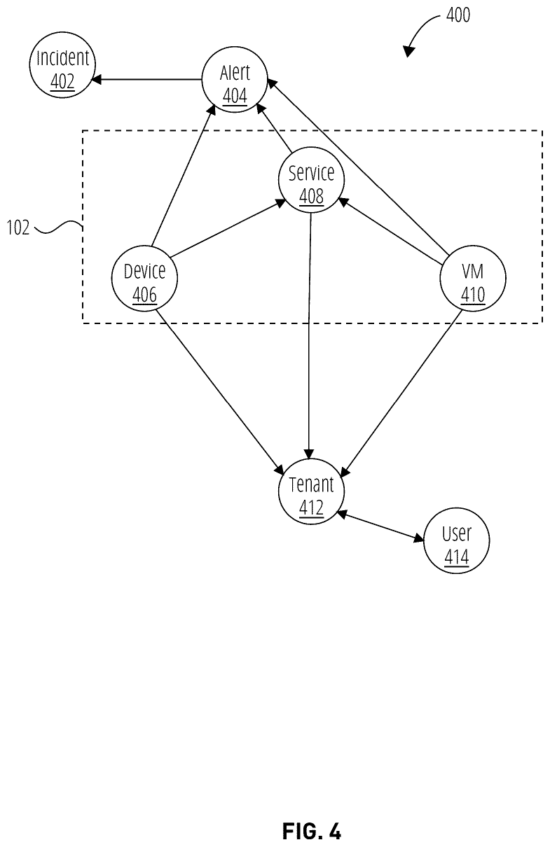

In some embodiments, the data source search APIs 114 may query and retrieve data based on specific criteria from one or more of the event data stores 106. In some embodiments, the data source search APIs 114 can filter and sort results, paginate large datasets, and support full-text search for keywords. In some embodiments, the data source search APIs 114 may also offer search suggestions and rank results by relevance. In some embodiments, one of the event data stores 106 may store graph information on data resources 102 and the associated entities and connections as described in FIG. 4. Based on the identification of entities associated with the data resource 102 associated with the incident, the event data manager 104 may provide the collaboration tools 216 with one or more entities to connect via the communication channel to address the issue.

In some embodiments, the data source search APIs 114 may be used to identify additional data that can be used by the event data manager 104, for example at the event monitor 202, to generate a potential solution to resolve the incident. The event data manager 104 may use the data from the event data stores 106, the historical data determined relevant by the similar incident identifier 218, and the like to generate the proposed solution. In some embodiments, the event data manager 104 may provide the proposed solution to the message processors 110 to translate the proposed solution into plain language to be provided to the entities using the communication channel.

In some embodiments, a user, such as an entity, may provide a request at a user device 214 to review the health or status of the data resources 102. The request may cause the collaboration tools 216 to generate a communication channel that can be used to request additional user from the entity. The request can, in some embodiments, include a request for information regarding the data resources 102, alternative parameters for identifying an incident, and the like. The request may be provided to message processors 110 to review the request and generate a response. The request may first be authenticated by an authenticator and request handler 220. The authenticator and request handler 220 may authenticate the request as a valid request that the user is allowed to make. Based on a request being successfully authenticated, the request may be provided to the LLM orchestrator 222.

In some embodiments, the LLM orchestrator 222 may manage and coordinate the use of multiple language models within a system to interpret the request. The LLM orchestrator 222 may enable the conversion of the request from plain language into language usable by the data source search API selector 112 to acquire the relevant data for the request, as described above. In some embodiments, the data source search API selector 112 may determine the request did not include enough information to properly or efficiently query the event data stores 106. The message processors 110 may generate a message using the message generator 232 and the LLM orchestrator 222 to provide to the entity using the communication channel of the collaboration tool 216. In some embodiments, the process to gain the request information may include multiple message generations to prompt the entity to provide enough information to generate a query using the query generator 228 for the data source search APIs 114.

After querying the event data stores 106, the data source search APIs 114 may provide the information to the message generator 232 to generate a response to the entity's initial request. When generating messages, the message generator 232 may utilize the LLM orchestrator 222 and an LLM inference server 234 to provide a plain language response.

In some embodiments, depending on the request, the query results of the request and/or the message generated by the message generator 232 for responding to the initial request may be provided to the event data manager 104. Based on the information from the request, such as new parameters, the event data manager 104 may identify an incident is occurring for one or more data resources 102 and may determine one or more additional entities to add to the communication channel to address the incident. For example, the prompt may be “Check if the temperature for the servers in server room 7 have exceeded 86 degrees F.” Even if a threshold temperature value for identifying an incident for the servers is set to 90 degrees, the information in the prompt may cause the event data manager 104 to identify an incident if the event data indicates a temperature above 86 degrees. The incident may be declared and any entities associated with the servers, temperature, or server room 7, may be added to the communication channel to address the issues.

In some embodiments, the event data will be provided back to the entity that input the request and the entity may identify the incident and cause the event data manager 104 to add the associated entities to the communication channel.

FIG. 3 a flow diagram of an incident process 300 for generating and updating communication channels for an incident on the architecture providing generative artificial intelligence incident response and management of IT systems of FIG. 2, according to at least one embodiment. As described above in FIGS. 1-2, a system, for example the system 200, can identify an incident to be addressed by a plurality of entities. A process for enabling communication between the plurality of entities, between the plurality of entities and the system 200, and the system 200 and additional entities is described by the incident process 300.

The incident process 300 begins when a major outage is incident identified 302, for example by automatic identification at the event data manager 104 of FIG. 2, or in response to a prompt from a user device 214. As described above, incident identification 302 can include determining affected event data resource 102, the plurality of entities associated with the event 102, and the like. Once the incident is identified, the incident process 300 may begin an incident initialization 304. The 304 may include creating a create communication channel 312, invite relevant entities 314, and generate and provide communication links 316.

In some embodiments, create communication channel 312 can include utilizing a collaboration tool to create a communication channel that can be used by the plurality of entities that were identified when the incident was incident identified 302. In some embodiments, the collaboration tools 216 can be used to generate communication channels such as text chats, video chat rooms, email chains, and the like. The incident process 300 can include the system 200 generating and/or providing invitations to the plurality of entities. In some embodiments, the invitation can include a notification of the incident and an indication that the entity should search for and connect to a communication channel. In some embodiments, the system 200 can generate and provide communication links 316. In some embodiments, the communication link can include an email providing a link to the communication channel, adding each entity of the plurality of entities into the permissions within the collaboration tool to view and interact with the channel, enabling automatic communication channel opening on work user devices, and the like.

The incident process 300 can continue during the course of the incident with incident updates 306. As described above, the communication channel can be used to provide potential solutions to resolve the incident to the plurality of entities connected via the communication channel. The communication channel may be monitored for entity actions. An entity action may include, but is not limited to, providing data to the communication channel, commenting within the communication channel, and/or reacting to comments within the communication channel. The system 200, for example at the event data manager 104, may utilize the entity actions during the incident to provide incident updates 306 to the system 200, for example to the vector data store 212, or to interested administrators. The system 200 may summarize the communication channel 318. A summary may include, for example, an overview of the incident, the first potential solution, actions taken by the plurality of entities to resolve the incident, updates to the potential solution generated based on entity actions and/or additional data, and the like. The summary may be translated into plain language for example, using a large language model. In some embodiments, the summary may be used to provide updates to administrators 320. Administrators may include entities that are not equipped to resolve the incident and therefore have no need to be connected via the communication channel but may be required to be kept informed of the incident and resolution attempts. The updates may be provided to an administrator once there is an update as indicated by an updated proposal, entity action, and/or additional data, at an interval, upon request, and the like. In some embodiments, the updates can be provided in a generated email.

In some embodiments, the summary may be used to update databases with the incident channel summaries 322. As described above, historical incident data may be used to generate proposed solutions for incidents. As an incident progresses, the summary may be used to store information into the vector data store 212 that can be later used as historical incident data.

Once the incident has been resolved 310, the incident process 300 can include incident resolution 308. During incident resolution 308, the system 200 can summarize final communication channel 324, provide resolution information to administrators 326, and update databases with final incident report 328 using the methods listed above.

FIG. 4 is a schematic block diagram of a map 400 of event data resources of an IT system, according to at least one embodiment. In some embodiments, one of the databases 208 can be used to store graphs of the data resource 102. A data resource 102 graph can be used by the event data manager 104 to interpret the interconnectivity of the data resource 102 to identify potential incidents and determine the plurality of entities to notify of the incident.

A device 406 may be a data resource 102 within the system 200. The device 406 may be, for example, a server. The device 406 may provide event data for the device 406, such as memory usage. The device 406 may run an application provided by a service 408. Event data for a service 408 running on the device 406 may include, for example, an application for connecting users to a network. The service 408 may generate user data such as connectivity timestamps and activity logs. In some embodiments, event data provided to the event data manager 104 from the service 408 may indicate a lack of activity in the activity logs. The event data manager 104, using the map 400 stored within a database 208, may identify the issue and may identify the device 406 connected with the service 408. The event data manager 104 may review real-time or non-real time data for the device 406 to identify if there is an issue with the device 406. In some embodiments, the event data from the device alone may not indicate an incident, but a combination of the event data of the device and the service 408 data may indicate an incident for the device 406.

In some embodiments, the data resource 102 may be a virtual machine (VM) 410. The VM 410 may be running as part of the service 408 and may provide data to the event data manager 104. Similar to the device 406, the event data from the VM 410 may indicate an issue with the service or the event data from the service 408 may indicate an issue with the VM 410.

The device 406, service 408, and VM 410 may all have a same tenant 412. The tenant 412 may be an organization that has ownership of the aforementioned. The users 414 of the tenant 412 may be entities that can resolve and monitor incidents. In some embodiments, users 414 can also be administrators that cannot resolve incidents, but are to be informed about incidents. In some embodiments, a user 414 can be associated with a tenant 412, a device 406, a service 408, and/or a VM 410. Upon identification of an incident 402 in any data resource 102 with which the user 414 is associated, the user 414 may be included with the plurality of entities that are part of the communication channel.

In some embodiments, an incident 402 for any of the data resource 102 can be determined using an alert 404 issued by one or more of the data resource 102. Indication of the data resource 102 associated with the alert 404 can enable the system 200 to identify the users 414 that are to be included in the communication channel to resolve the incident 402.

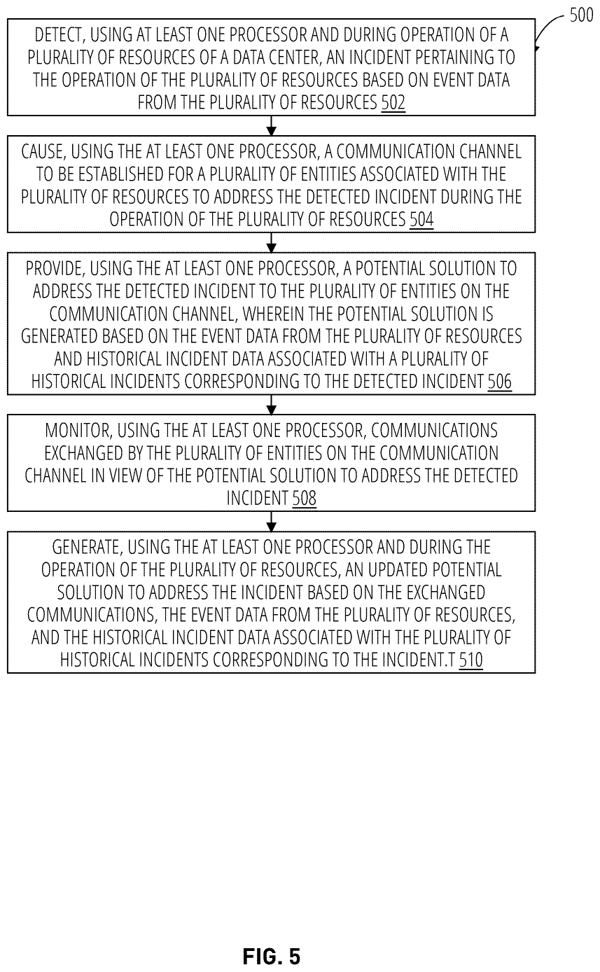

FIG. 5 is a flow diagram of an example method 500 of generative artificial intelligence incident response and management of IT systems, according to at least one embodiment. In block 502, routine 500 during operation of a plurality of resources of a data center, detect, based on a real time identification, an incident using event data from one or more event data resources 102 of a plurality of event data resources 102. In some embodiments, the system may identify a plurality of entities associated with the one or more event data resources 102 to address the incident in real time. In some embodiments, the event data resources 102 may be data sources within an information technology (IT) system that produce data. For example, a data source can be a hardware asset, a software asset, a network asset, a data asset, an intangible asset, a cloud asset, storage devices, an alert, a log, monitoring tools, and the like. As described in FIGS. 1-2, data resources 102 can provide data to event data manager 104. Event data managers 104 may include event monitors 202, message queues 204, worker nodes 206, worker nodes 210. Each data resource 102 may be associated with an individual event data manager 104. The event monitor 202 may receive data in real time or near-real time and review the data to determine if there is a potential issue within one or more of the data resources 102. For example, the event monitor 202 may receive data from a first server in a server room and a second server in a server room that they have ceased receiving transmissions from a first server. The event monitor 202 may determine that the third server is experiencing an outage.

In some embodiments, monitoring event data of the plurality of event data resources can enable identification of the incident based on the event data indicating the one or more event data resources require real time intervention from the plurality of entities. In some embodiments, an incident may be defined if an outage rises to a level of being significant. In some embodiments, significance can be determined using historical data of previous incidents. For example, a historical data may show that a single hardware piece having an outage caused widespread effects. Thus, any outage of that hardware piece may be considered an incident. In some embodiments, an incident may be determined based on multiple data resources 102 providing data that indicates widespread issues with data resources 102 for example, multiple data resources 102 indicating alerts. In some embodiments, a lack of data may be used to identify an incident. For example, a data resource 102 that regularly provides data can be identified as being part of an incident if the data resource 102 stops providing event data to the event data manager 104.

In some embodiments at block 504, after identifying an incident, the event data manager 104 may establish a communication channel to allow a plurality of entities to communicate regarding the incident and to address the detected incident during the operation of the plurality of resources. In some embodiments, the plurality of entities may include one or more data technicians, engineers, administrators, and the like that are interested parties in incidents of the IT system and incident resolvers. In some embodiments, each incident of an IT system may be associated with a different plurality of entities. The plurality of entities may be identified based on characteristics of the incident. An incident characteristic can include the data resources affected, the data type, and the like. For example, an incident can be localized to a set of servers. The plurality of entities may be selected based on the entities that are associated with the servers. In an additional example, the incident may indicate, via alerts, of a rising temperature near hardware devices. The plurality of entities may include technicians and engineers that can address local temperature increases, either through proximity to the hardware devices or knowledge of heating and cooling systems near the hardware devices. Additional entities may include managers and administrators that the technicians and engineers may report to or otherwise may be interested in the incident.

In some embodiments, an incident may be identified, not automatically through data analysis using, for example, the event data manager 104, but by receiving a request from a user of a user device 214. The request may be provided to the system for maintenance. For example, a request may be to identify any severs that are operating above a specific temperature. The temperature may not be the same temperature that may be automatically called an incident by the event data manager 104. Using the request as a parameter to determine an incident, the event data manager 104 may identify an incident and generate a communication as stated above. In some embodiments to identify an incident, the system may generate a query for one or more event data stores 106. The query may be directed to acquiring data to determine an incident based on stored data. The data collected from the query may be used to provide a response to the user that can indicate an identified incident or return the data that was requested, or the like.

In block 506, the system, for example at the event data manager 104, provides a potential solution for addressing the detected incident t to the plurality of entities on a generated communication channel. In some embodiments, the potential solution is generated using the event data from the one or more event data resources and historical incident data from a plurality of historical incidents associated with the incident. In some embodiments, the potential solution can advise the plurality of entities, through the generated communication channel, of actions to take based on actions that may have been beneficial in past incidents. The past incidents may be selected, for example using the similar incident identifier 218, based on a relevancy confidence of the historical incident data satisfies a threshold, the relevancy confidence indicating a relevancy of the historical incident data to the incident. For example, the similar incident identifier 218 may receive data regarding the identified incident from the event data manager 104 and may query a vector data store 212 that may store data associated with past incidents. The similar incident identifier 218 may review the data and compare it to the incident to determine a relevancy of the historical incident data to the incident. Based on the relevancy meeting a threshold, the similar incident identifier 218 may provide the relevant data, such as solutions tried and not tried, to the event data manager 104 to aid in generation of a potential solution.

In block 508, the system may, responsive to providing the potential solution to the plurality of entities on the communication channel, monitor one or more entity actions on the communication channel in view of the potential solution to address the detected incident. In some embodiments, the entity actions can be messages or reactions to messages within the communication channel. For example, an engineer may supply a message to the communication channel to indicate that the engineer tried to implement the potential solution and the problem did not persist.

In block 510, based on monitoring the one or more entity actions on the communication channel, the system, for example at the event data manager 104, may provide an updated potential solution to address the incident in real time based on the one or more entity actions, event data from the one or more data resources, and historical incident data from the plurality of historical incidents associated with the incident. In some embodiments, upon resolution of the incident, updating a historical incident data store with historical incident data associated with the incident. In some embodiments, based on a resolution of the incident, providing a generated summary of the incident and the one or more entity actions to a historical incident data store. In some embodiments, the system may provide the updated potential solution to at least one of the plurality of entities to ensure uninterrupted operation of the plurality of resources of the data center.

### Inference and Training Logic

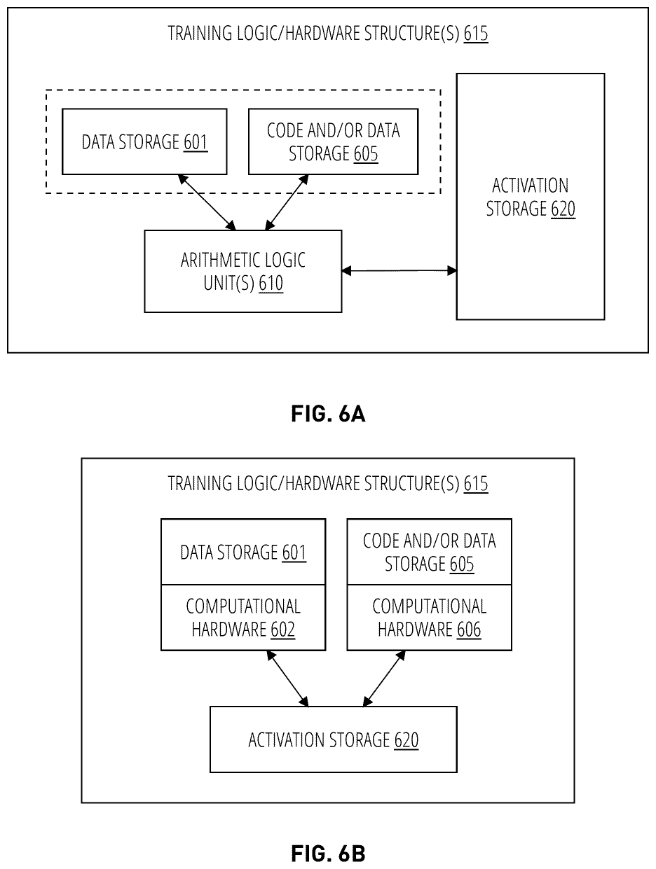

FIG. 6A illustrates inference and/or training logic/hardware structure(s) 615 used to perform inferencing and/or training operations associated with one or more embodiments.

In at least one embodiment, inference and/or training logic 615 may include, without limitation, code and/or data storage 601 to store forward and/or output weight and/or input/output data, and/or other parameters to configure neurons or layers of a neural network trained and/or used for inferencing in aspects of one or more embodiments. In at least one embodiment, training logic 615 may include, or be coupled to code and/or data storage 601 to store graph code or other software to control timing and/or order, in which weight and/or other parameter information is to be loaded to configure, logic, including integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code, and/or data storage 601 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 601 may be included with other on-chip or off-chip data storage, including a processor's L1, L2, or L3 cache or system memory.

In at least one embodiment, any portion of code and/or data storage 601 may be internal or external to one or more processors or other hardware logic devices or circuits. In at least one embodiment, code and/or code and/or data storage 601 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 601 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference, and/or training logic 615 may include, without limitation, a code and/or data storage 605 to store backward and/or output weight and/or input/output data corresponding to neurons or layers of a neural network trained and/or used for inferencing in aspects of one or more embodiments. In at least one embodiment, code, and/or data storage 605 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 615 may include, or be coupled to code and/or data storage 605 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 605 may be included with other on-chip or off-chip data storage, including a processor's L1, L2, or L3 cache or system memory. In at least one embodiment, any portion of code and/or data storage 605 may be internal or external to one or more processors or other hardware logic devices or circuits. In at least one embodiment, code, and/or data storage 605 may be cache memory, DRAM, SRAM, non-volatile memory (e.g., flash memory), or other storage. In at least one embodiment, a choice of whether code and/or data storage 605 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code, and/or data storage 601 and code and/or data storage 605 may be separate storage structures. In at least one embodiment, code, and/or data storage 601 and code and/or data storage 605 may be a combined storage structure. In at least one embodiment, code, and/or data storage 601 and code and/or data storage 605 may be partially combined and partially separate. In at least one embodiment, any portion of code and/or data storage 601 and code and/or data storage 605 may be included with other on-chip or off-chip data storage, including a processor's L1, L2, or L3 cache or system memory.

In at least one embodiment, inference and/or training logic 615 may include, without limitation, one or more arithmetic logic unit(s) (“ALU(s)”) 610, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 620 that are functions of input/output and/or weight parameter data stored in code and/or data storage 601 and/or code and/or data storage 605.

In at least one embodiment, activations stored in activation storage 620 are generated according to linear algebraic and or matrix-based mathematics performed by ALU(s) 610 in response to performing instructions or other code, wherein weight values stored in code and/or data storage 605 and/or data storage 601 are used as operands along with other values, such as bias values, gradient information, momentum values, or other parameters or hyperparameters, any or all of which may be stored in code and/or data storage 605 or code and/or data storage 601 or another storage on or off-chip.

In at least one embodiment, ALU(s) 610 are included within one or more processors or other hardware logic devices or circuits, whereas in another embodiment, ALU(s) 610 may be external to a processor or other hardware logic device or circuit that uses them (e.g., a co-processor). In at least one embodiment, ALU(s) 610 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 601, code and/or data storage 605, and activation storage 620 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 620 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement, and/or other logical circuits.

In at least one embodiment, activation storage 620 may be cache memory, DRAM, SRAM, non-volatile memory (e.g., flash memory), or other storage. In at least one embodiment, activation storage 620 may be completely or partially within or external to one or more processors or other logical circuits. In at least one embodiment, a choice of whether activation storage 620 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

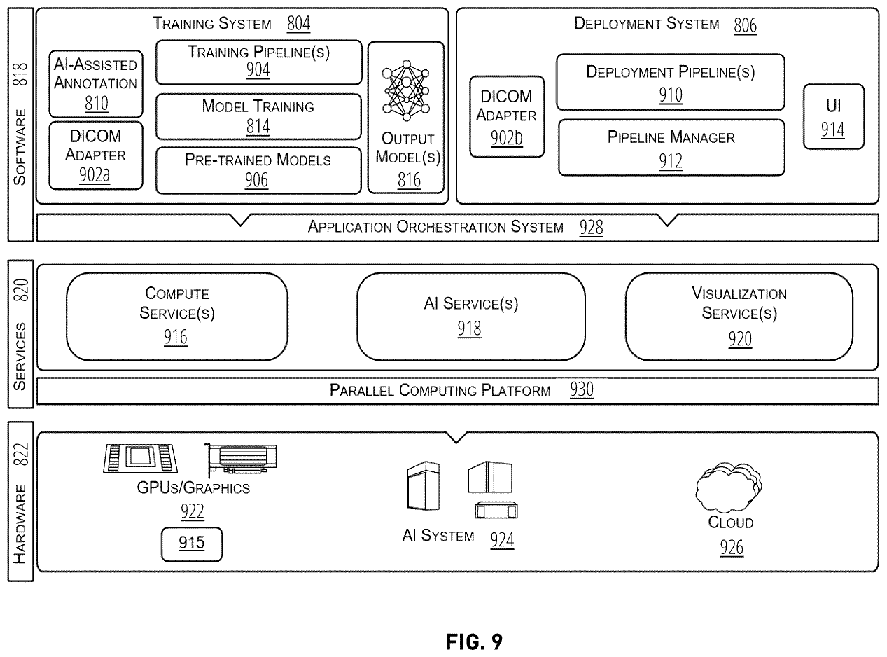

In at least one embodiment, inference, and/or training logic 615 illustrated in FIG. 9A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference, and/or training logic 615 illustrated in FIG. 9A may be used in conjunction with central processing unit (“CPU”) hardware, graphics processing unit (“GPU”) hardware or other hardware, such as field programmable gate arrays (“FPGAs”).

FIG. 6B illustrates inference and/or training logic 615, according to at least one embodiment. In at least one embodiment, inference, and/or training logic 615 may include, without limitation, hardware logic in which computational resources are dedicated or otherwise exclusively used in conjunction with weight values or other information corresponding to one or more layers of neurons within a neural network. In at least one embodiment, inference, and/or training logic 615 illustrated in FIG. 6B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference, and/or training logic 615 illustrated in FIG. 6B may be used in conjunction with central processing unit (CPU) hardware, graphics processing unit (GPU) hardware or other hardware, such as field programmable gate arrays (FPGAs). In at least one embodiment, inference and/or training logic 615 includes, without limitation, code and/or data storage 601 and code and/or data storage 605, which may be used to store code (e.g., graph code), weight values and/or other information, including bias values, gradient information, momentum values, and/or other parameter or hyperparameter information. In at least one embodiment illustrated in FIG. 6B, each of code and/or data storage 601 and code and/or data storage 605 is associated with a dedicated computational resource, such as computational hardware 602 and computational hardware 606, respectively. In at least one embodiment, each of computational hardware 602 and computational hardware 606 comprises one or more ALUs that perform mathematical functions, such as linear algebraic functions, only on information stored in code and/or data storage 601 and code and/or data storage 605, respectively, result of which is stored in activation storage 620.

In at least one embodiment, each of code and/or data storage 601 and 605 and corresponding computational hardware 602 and 606, respectively, correspond to different layers of a neural network, such that resulting activation from one storage/computational pair 601/602 of code and/or data storage 601 and computational hardware 602 is provided as an input to a next storage/computational pair 605/606 of code and/or data storage 605 and computational hardware 606, in order to mirror a conceptual organization of a neural network. In at least one embodiment, each of storage/computational pairs 601/602 and 605/606 may correspond to more than one neural network layer. In at least one embodiment, additional storage/computation pairs (not shown) subsequent to or in parallel with storage/computation pairs 601/602 and 605/606 may be included in inference and/or training logic 615.

### Neural Network Training and Deployment

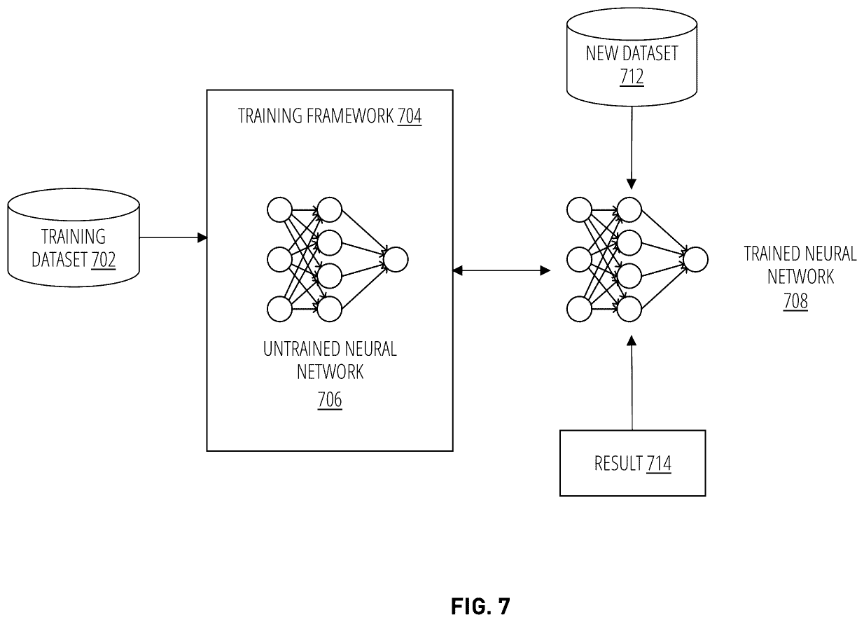

FIG. 7 illustrates training and deployment of a deep neural network, according to at least one embodiment. In at least one embodiment, untrained neural network 706 is trained using a training dataset 702. In at least one embodiment, training framework 704 is a PyTorch framework, whereas in other embodiments, training framework 704 is a TensorFlow, Boost, Caffe, Microsoft Cognitive Toolkit/CNTK, MXNet, Chainer, Keras, Deeplearning4j, or other training framework. In at least one embodiment, training framework 704 trains an untrained neural network 706 and enables it to be trained using processing resources described herein to generate a trained neural network 708. In at least one embodiment, weights may be chosen randomly or by pre-training using a deep belief network. In at least one embodiment, training may be performed in either a supervised, partially supervised, or unsupervised manner.

In at least one embodiment, untrained neural network 706 is trained using supervised learning, wherein training dataset 702 includes an input paired with a desired output for an input, or where training dataset 702 includes input having a known output and an output of neural network 706 is manually graded. In at least one embodiment, untrained neural network 706 is trained in a supervised manner and processes inputs from training dataset 702 and compares resulting outputs against a set of expected or desired outputs. In at least one embodiment, errors are then propagated back through untrained neural network 706. In at least one embodiment, training framework 704 adjusts weights that control untrained neural network 706. In at least one embodiment, training framework 704 includes tools to monitor how well untrained neural network 706 is converging towards a model, such as trained neural network 708, suitable to generating correct answers, such as in result 714, based on input data such as a new dataset 712. In at least one embodiment, training framework 704 trains untrained neural network 706 repeatedly while adjusting weights to refine an output of untrained neural network 706 using a loss function and adjustment algorithm, such as stochastic gradient descent. In at least one embodiment, training framework 704 trains untrained neural network 706 until untrained neural network 706 achieves a desired accuracy. In at least one embodiment, trained neural network 708 can then be deployed to implement any number of machine learning operations.

In at least one embodiment, untrained neural network 706 is trained using unsupervised learning, whereas untrained neural network 706 attempts to train itself using unlabeled data. In at least one embodiment, unsupervised learning training dataset 702 will include input data without any associated output data or “ground truth” data. In at least one embodiment, untrained neural network 706 can learn groupings within training dataset 702 and can determine how individual inputs are related to untrained dataset 702. In at least one embodiment, unsupervised training can be used to generate a self-organizing map in trained neural network 708 capable of performing operations useful in reducing dimensionality of new dataset 712. In at least one embodiment, unsupervised training can also be used to perform anomaly detection, which allows identification of data points in new dataset 712 that deviate from normal patterns of new dataset 712.

In at least one embodiment, semi-supervised learning may be used, which is a technique in which in training dataset 702 includes a mix of labeled and unlabeled data. In at least one embodiment, training framework 704 may be used to perform incremental learning, such as through transferred learning techniques. In at least one embodiment, incremental learning enables trained neural network 708 to adapt to new dataset 712 without forgetting knowledge instilled within trained neural network 708 during initial training.

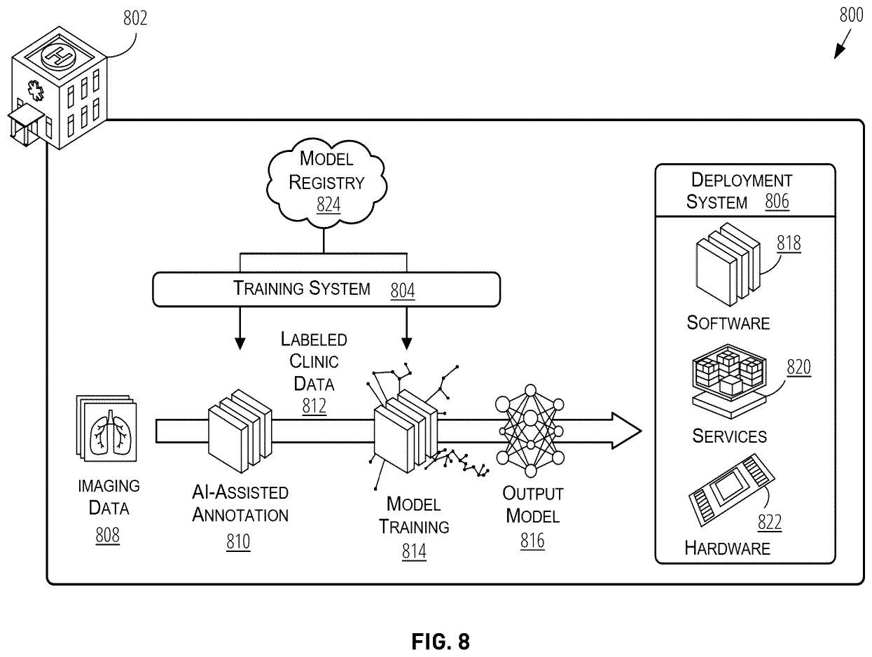

With reference to FIG. 8, FIG. 8 is an example data flow diagram for a process 800 of generating and deploying a processing and inferencing pipeline, according to at least one embodiment. . . . In at least one embodiment, process 800 may be deployed to perform game name recognition analysis and inferencing on user feedback data at one or more facilities 802, such as a data center.

In at least one embodiment, process 800 may be executed within a training system 804 and/or a deployment system 806. In at least one embodiment, training system 804 may be used to perform training, deployment, and embodiment of machine learning models (e.g., neural networks, object detection algorithms, computer vision algorithms, etc.) for use in deployment system 806. In at least one embodiment, deployment system 806 may be configured to offload processing and compute resources among a distributed computing environment to reduce infrastructure requirements at facility 802. In at least one embodiment, deployment system 806 may provide a streamlined platform for selecting, customizing, and implementing virtual instruments for use with computing devices at facility 802. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 806 during execution of applications.

In at least one embodiment, some applications used in advanced processing and inferencing pipelines may use machine learning models or other AI to perform one or more processing steps. In at least one embodiment, machine learning models may be trained at facility 802 using feedback data 808 (such as imaging data) stored at facility 802 or feedback data 808 from another facility or facilities, or a combination thereof. In at least one embodiment, training system 804 may be used to provide applications, services, and/or other resources for generating working, deployable machine learning models for deployment system 806.

In at least one embodiment, a model registry 824 may be backed by object storage that may support versioning and object metadata. In at least one embodiment, object storage may be accessible through, for example, a cloud storage (e.g., a cloud 926 of FIG. 12) compatible application programming interface (API) from within a cloud platform. In at least one embodiment, machine learning models within model registry 824 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 904 (FIG. 12) may include a scenario where facility 802 is training their own machine learning model or has an existing machine learning model that needs to be optimized or updated. In at least one embodiment, feedback data 808 may be received from various channels, such as forums, web forms, or the like. In at least one embodiment, once feedback data 808 is received, AI-assisted annotation 810 may be used to aid in generating annotations corresponding to feedback data 808 to be used as ground truth data for a machine learning model. In at least one embodiment, AI-assisted annotation 810 may include one or more machine learning models (e.g., convolutional neural networks (CNNs)) that may be trained to generate annotations corresponding to certain types of feedback data 808 (e.g., from certain devices) and/or certain types of anomalies in feedback data 808. In at least one embodiment, AI-assisted annotations 810 may then be used directly, or may be adjusted or fine-tuned using an annotation tool, to generate ground truth data. In at least one embodiment, in some examples, labeled data 812 may be used as ground truth data for training a machine learning model. In at least one embodiment, AI-assisted annotations 810, labeled data 812, or a combination thereof may be used as ground truth data for training a machine learning model, e.g., via model training 814 in FIGS. 6-7. In at least one embodiment, a trained machine learning model may be referred to as an output model 816, and may be used by deployment system 806, as described herein.

In at least one embodiment, training pipeline 904 (FIG. 9) may include a scenario where facility 802 needs a machine learning model for use in performing one or more processing tasks for one or more applications in deployment system 806, but facility 802 may not currently have such a machine learning model (or may not have a model that is optimized, efficient, or effective for such purposes). In at least one embodiment, an existing machine learning model may be selected from model registry 824. In at least one embodiment, model registry 824 may include machine learning models trained to perform a variety of different inference tasks on imaging data. In at least one embodiment, machine learning models in model registry 824 may have been trained on imaging data from different facilities than facilities 802 (e.g., facilities that are remotely located). In at least one embodiment, machine learning models may have been trained on imaging data from one location, two locations, or any number of locations. In at least one embodiment, when being trained on imaging data, which may be a form of feedback data 808, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained- or partially trained—at one location, a machine learning model may be added to model registry 824. In at least one embodiment, a machine learning model may then be retrained, or updated, at any number of other facilities, and a retrained or updated model may be made available in model registry 824. In at least one embodiment, a machine learning model may then be selected from model registry 824—and referred to as output model 816—and may be used in deployment system 806 to perform one or more processing tasks for one or more applications of a deployment system.

In at least one embodiment, training pipeline 904 (FIG. 9) may be used in a scenario that includes facility 802 requiring a machine learning model for use in performing one or more processing tasks for one or more applications in deployment system 806, but facility 802 may not currently have such a machine learning model (or may not have a model that is optimized, efficient, or effective for such purposes). In at least one embodiment, a machine learning model selected from model registry 824 might not be fine-tuned or optimized for feedback data 808 generated at facility 802 because of differences in populations, genetic variations, robustness of training data used to train a machine learning model, diversity in anomalies of training data, and/or other issues with training data. In at least one embodiment, AI-assisted annotation 810 may be used to aid in generating annotations corresponding to feedback data 808 to be used as ground truth data for retraining or updating a machine learning model. In at least one embodiment, labeled data 812 may be used as ground truth data for training a machine learning model. In at least one embodiment, retraining or updating a machine learning model may be referred to as model training 814. In at least one embodiment, model training 814—e.g., AI-assisted annotations 810, labeled data 812, or a combination thereof—may be used as ground truth data for retraining or updating a machine learning model.

In at least one embodiment, deployment system 806 may include software 818, services 820, hardware 822, and/or other components, features, and functionality. In at least one embodiment, deployment system 806 may include a software “stack,” such that software 818 may be built on top of services 820 and may use services 820 to perform some or all of processing tasks, and services 820 and software 818 may be built on top of hardware 822 and use hardware 822 to execute processing, storage, and/or other compute tasks of deployment system 806.

In at least one embodiment, software 818 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 808 (or other data types, such as those described herein). In at least one embodiment, an advanced processing and inferencing pipeline may be defined based on selections of different containers that are desired or required for processing feedback data 808, in addition to containers that receive and configure imaging data for use by each container and/or for use by facility 802 after processing through a pipeline (e.g., to convert outputs back to a usable data type for storage and display at facility 802). In at least one embodiment, a combination of containers within software 818 (e.g., that make up a pipeline) may be referred to as a virtual instrument (as described in more detail herein), and a virtual instrument may leverage services 820 and hardware 822 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 816 of training system 804.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 824 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 820 as a system (e.g., system 900 of FIG. 9). In at least one embodiment, once validated by system 900 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 900 of FIG. 9). In at least one embodiment, completed and validated applications or containers may be stored in a container registry and associated machine learning models may be stored in model registry 824. In at least one embodiment, a requesting entity that provides an inference or image processing request may browse a container registry and/or model registry 824 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 806 (e.g., a cloud) to perform processing of a data processing pipeline. In at least one embodiment, processing by deployment system 806 may include referencing selected elements (e.g., applications, containers, models, etc.) from a container registry and/or model registry 824. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 820 may be leveraged. In at least one embodiment, services 820 may include compute services, collaborative content creation services, simulation services, artificial intelligence (AI) services, visualization services, and/or other service types. In at least one embodiment, services 820 may provide functionality that is common to one or more applications in software 818, so functionality may be abstracted to a service that may be called upon or leveraged by applications. In at least one embodiment, functionality provided by services 820 may run dynamically and more efficiently, while also scaling well by allowing applications to process data in parallel, e.g., using a parallel computing platform 930 (FIG. 9). In at least one embodiment, rather than each application that shares a same functionality offered by a service 820 being required to have a respective instance of service 820, service 820 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 820 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 818 implementing advanced processing and inferencing pipeline may be streamlined because each application may call upon the same inference service to perform one or more inferencing tasks.

In at least one embodiment, hardware 822 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 822 may be used to provide efficient, purpose-built support for software 818 and services 820 in deployment system 806. In at least one embodiment, use of GPU processing may be implemented for processing locally (e.g., at facility 802), within an AI/deep learning system, in a cloud system, and/or in other processing components of deployment system 806 to improve efficiency, accuracy, and efficacy of game name recognition.

In at least one embodiment, software 818 and/or services 820 may be optimized for GPU processing with respect to deep learning, machine learning, and/or high-performance computing, simulation, and visual computing, as non-limiting examples. In at least one embodiment, at least some of the computing environment of deployment system 806 and/or training system 804 may be executed in a datacenter or one or more supercomputers or high performance computing systems, with GPU-optimized software (e.g., hardware and software combination of NVIDIA's DGX™ system). In at least one embodiment, hardware 822 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 9 is a system diagram for an example system 900 for generating and deploying a deployment pipeline, according to at least one embodiment. In at least one embodiment, system 1200 may be used to implement process 800 of FIG. 6 and/or other processes including advanced processing and inferencing pipelines. In at least one embodiment, system 900 may include training system 804 and deployment system 806. In at least one embodiment, training system 804 and deployment system 806 may be implemented using software 818, services 1120, and/or hardware 822, as described herein.

In at least one embodiment, system 900 (e.g., training system 804 and/or deployment system 806) may implemented in a cloud computing environment (e.g., using cloud 926). In at least one embodiment, system 900 may be implemented locally with respect to a facility, or as a combination of both cloud and local computing resources. . . . In at least one embodiment, access to APIs in cloud 926 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 900, may be restricted to a set of public internet service providers (ISPs) that have been vetted or authorized for interaction.

In at least one embodiment, various components of system 900 may communicate between and among one another using any of a variety of different network types, including but not limited to local area networks (LANs) and/or wide area networks (WANs) via wired and/or wireless communication protocols. In at least one embodiment, communication between facilities and components of system 900 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 804 may execute training pipelines 904, similar to those described herein with respect to FIG. 6. In at least one embodiment, where one or more machine learning models are to be used in deployment pipelines 910 by deployment system 806, training pipelines 904 may be used to train or retrain one or more (e.g., pre-trained) models, and/or implement one or more of pre-trained models 906 (e.g., without a need for retraining or updating). In at least one embodiment, as a result of training pipelines 904, output model(s) 816 may be generated. In at least one embodiment, training pipelines 904 may include any number of processing steps, AI-assisted annotation 810, labeling or annotating of feedback data 808 to generate labeled data 812, model selection from a model registry, model training 814, training, retraining, or updating models, and/or other processing steps. In at least one embodiment, for different machine learning models used by deployment system 806, different training pipelines 904 may be used. In at least one embodiment, training pipeline 904, similar to a first example described with respect to FIG. 6, may be used for a first machine learning model, training pipeline 904, similar to a second example described with respect to FIG. 6, may be used for a second machine learning model, and training pipeline 904, similar to a third example described with respect to FIG. 6, may be used for a third machine learning model. In at least one embodiment, any combination of tasks within training system 804 may be used depending on what is required for each respective machine learning model. In at least one embodiment, one or more of machine learning models may already be trained and ready for deployment so machine learning models may not undergo any processing by training system 804 and may be implemented by deployment system 806.

In at least one embodiment, output model(s) 816 and/or pre-trained model(s) 906 may include any types of machine learning models depending on embodiment. In at least one embodiment, and without limitation, machine learning models used by system 900 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 904 may include AI-assisted annotation. In at least one embodiment, labeled data 812 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 808 (or other data type used by machine learning models), there may be corresponding ground truth data generated by training system 804. In at least one embodiment, AI-assisted annotation may be performed as part of deployment pipelines 910; either in addition to, or in lieu of, AI-assisted annotation included in training pipelines 904. In at least one embodiment, system 900 may include a multi-layer platform that may include a software layer (e.g., software 818) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 802. In at least one embodiment, applications may then call or execute one or more services 820 for performing compute, AI, or visualization tasks associated with respective applications, and software 818 and/or services 820 may leverage hardware 822 to perform processing tasks in an effective and efficient manner.

In at least one embodiment, deployment system 806 may execute deployment pipelines 910. In at least one embodiment, deployment pipelines 910 may include any number of applications that may be sequentially, non-sequentially, or otherwise applied to feedback data (and/or other data types), including AI-assisted annotation, as described above. In at least one embodiment, as described herein, a deployment pipeline 910 for an individual device may be referred to as a virtual instrument for a device. In at least one embodiment, for a single device, there may be more than one deployment pipeline 910 depending on information desired from data generated by a device.

In at least one embodiment, applications available for deployment pipelines 910 may include any application that may be used for performing processing tasks on feedback data or other data from devices. In at least one embodiment, because various applications may share common image operations, in some embodiments, a data augmentation library (e.g., as one of services 820) may be used to accelerate these operations. In at least one embodiment, to avoid bottlenecks of conventional processing approaches that rely on CPU processing, parallel computing platform 930 may be used for GPU acceleration of these processing tasks.

In at least one embodiment, deployment system 806 may include a user interface (UI) 914 (e.g., a graphical user interface, a web interface, etc.) that may be used to select applications for inclusion in deployment pipeline(s) 910, arrange applications, modify or change applications or parameters or constructs thereof, use and interact with deployment pipeline(s) 910 during set-up and/or deployment, and/or to otherwise interact with deployment system 806. In at least one embodiment, although not illustrated with respect to training system 804, UI 914 (or a different user interface) may be used for selecting models for use in deployment system 806, for selecting models for training, or retraining, in training system 804, and/or for otherwise interacting with training system 804. In at least one embodiment, training system 804 and deployment system 806 may include DICOM adapters 902A and 902B.

In at least one embodiment, pipeline manager 912 may be used, in addition to an application orchestration system 728, to manage interaction between applications or containers of deployment pipeline(s) 910 and services 820 and/or hardware 822. In at least one embodiment, pipeline manager 912 may be configured to facilitate interactions from application to application, from application to service 820, and/or from application or service to hardware 822. In at least one embodiment, although illustrated as included in software 818, this is not intended to be limiting, and in some examples pipeline manager 912 may be included in services 820. In at least one embodiment, application orchestration system 728 (e.g., Kubernetes, DOCKER, etc.) may include a container orchestration system that may group applications into containers as logical units for coordination, management, scaling, and deployment. In at least one embodiment, by associating applications from deployment pipeline(s) 910 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 912 and application orchestration system 728. In at least one embodiment, so long as an expected input and/or output of each container or application is known by a system (e.g., based on constructs of applications or containers), application orchestration system 728 and/or pipeline manager 912 may facilitate communication among and between, and sharing of resources among and between, each of applications or containers. In at least one embodiment, because one or more of applications or containers in deployment pipeline(s) 910 may share the same services and resources, application orchestration system 728 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 728) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 820 leveraged and shared by applications or containers in deployment system 806 may include compute services 916, collaborative content creation services 917, AI services 918, simulation services 919, visualization services 920, and/or other service types. In at least one embodiment, applications may call (e.g., execute) one or more of services 820 to perform processing operations for an application. In at least one embodiment, compute services 916 may be leveraged by applications to perform super-computing or other high-performance computing (HPC) tasks. In at least one embodiment, compute service(s) 916 may be leveraged to perform parallel processing (e.g., using a parallel computing platform 930) for processing data through one or more of applications and/or one or more tasks of a single application, substantially simultaneously. In at least one embodiment, parallel computing platform 930 (e.g., NVIDIA's CUDA®) may enable general purpose computing on GPUs (GPGPU) (e.g., GPUs 922). In at least one embodiment, a software layer of parallel computing platform 930 may provide access to virtual instruction sets and parallel computational elements of GPUs, for execution of compute kernels. In at least one embodiment, parallel computing platform 930 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 930 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 918 may be leveraged to perform inferencing services for executing machine learning model(s) associated with applications (e.g., tasked with performing one or more processing tasks of an application). In at least one embodiment, AI services 918 may leverage AI system 924 to execute machine learning model(s) (e.g., neural networks, such as CNNs) for segmentation, reconstruction, object detection, feature detection, classification, and/or other inferencing tasks. In at least one embodiment, applications of deployment pipeline(s) 910 may use one or more of output models 816 from training system 804 and/or other models of applications to perform inference on imaging data (e.g., DICOM data, RIS data, CIS data, REST compliant data, RPC data, raw data, etc.). In at least one embodiment, two or more examples of inferencing using application orchestration system 928 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 928 may distribute resources (e.g., services 820 and/or hardware 822) based on priority paths for different inferencing tasks of AI services 918.

In at least one embodiment, shared storage may be mounted to AI services 918 within system 1200. In at least one embodiment, shared storage may operate as a cache (or other storage device type) and may be used to process inference requests from applications. In at least one embodiment, when an inference request is submitted, a request may be received by a set of API instances of deployment system 806, and one or more instances may be selected (e.g., for best fit, for load balancing, etc.) to process a request. In at least one embodiment, to process a request, a request may be entered into a database, a machine learning model may be located from model registry 824 if not already in a cache, a validation step may ensure appropriate machine learning model is loaded into a cache (e.g., shared storage), and/or a copy of a model may be saved to a cache. In at least one embodiment, the scheduler (e.g., of pipeline manager 912) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 1120 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 926, and an inference service may perform inferencing on a GPU.

In at least one embodiment, visualization services 920 may be leveraged to generate visualizations for viewing outputs of applications and/or deployment pipeline(s) 910. In at least one embodiment, GPUs 922 may be leveraged by visualization services 920 to generate visualizations. In at least one embodiment, rendering effects, such as ray-tracing or other light transport simulation techniques, may be implemented by visualization services 920 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 920 may include an internal visualizer, cinematics, and/or other rendering or image processing capabilities or functionality (e.g., ray tracing, rasterization, internal optics, etc.).

In at least one embodiment, hardware 822 may include GPUs 922, AI system 924, cloud 926, and/or any other hardware used for executing training system 804 and/or deployment system 806. In at least one embodiment, GPUs 922 (e.g., NVIDIA's TESLA® and/or QUADRO® GPUs) may include any number of GPUs that may be used for executing processing tasks of compute services 916, collaborative content creation services 917, AI services 918, simulation services 1219, visualization services 920, other services, and/or any of features or functionality of software 818. For example, with respect to AI services 918, GPUs 922 may be used to perform pre-processing on imaging data (or other data types used by machine learning models), post-processing on outputs of machine learning models, and/or to perform inferencing (e.g., to execute machine learning models). In at least one embodiment, cloud 926, AI system 924, and/or other components of system 1200 may use GPUs 922. In at least one embodiment, cloud 926 may include a GPU-optimized platform for deep learning tasks. In at least one embodiment, AI system 924 may use GPUs, and cloud 926—or at least a portion tasked with deep learning or inferencing—may be executed using one or more AI systems 924. As such, although hardware 822 is illustrated as discrete components, this is not intended to be limiting, and any components of hardware 822 may be combined with, or leveraged by, any other components of hardware 822.

In at least one embodiment, AI system 924 may include a purpose-built computing system (e.g., a super-computer or an HPC) configured for inferencing, deep learning, machine learning, and/or other artificial intelligence tasks. In at least one embodiment, AI system 924 (e.g., NVIDIA's DGX™) may include GPU-optimized software (e.g., a software stack) that may be executed using a plurality of GPUs 922, in addition to CPUs, RAM, storage, and/or other components, features, or functionality. In at least one embodiment, one or more AI systems 924 may be implemented in cloud 926 (e.g., in a data center) for performing some or all of AI-based processing tasks of system 1200.

In at least one embodiment, cloud 926 may include a GPU-accelerated infrastructure (e.g., NVIDIA's NGC™) that may provide a GPU-optimized platform for executing processing tasks of system 1200. In at least one embodiment, cloud 926 may include an AI system(s) 924 for performing one or more of AI-based tasks of system 1200 (e.g., as a hardware abstraction and scaling platform). In at least one embodiment, cloud 926 may integrate with application orchestration system 928 leveraging multiple GPUs to enable seamless scaling and load balancing between and among applications and services 820. In at least one embodiment, cloud 926 may be tasked with executing at least some of services 820 of system 1200, including compute services 916, AI services 918, and/or visualization services 920, as described herein. In at least one embodiment, cloud 926 may perform small and large batch inference (e.g., executing NVIDIA's TensorRT™), provide an accelerated parallel computing API and platform 930 (e.g., NVIDIA's CUDA®), execute application orchestration system 728 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1200.

In at least one embodiment, in an effort to preserve patient confidentiality (e.g., where patient data or records are to be used off-premises), cloud 926 may include a registry, such as a deep learning container registry. In at least one embodiment, a registry may store containers for instantiations of applications that may perform pre-processing, post-processing, or other processing tasks on patient data. In at least one embodiment, cloud 926 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)-such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures-such as those that rely on self-attention and/or cross-attention (e.g., between contextual data and textual data) mechanisms-may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type-including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s) and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.-as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model- or version, instance, or agent-maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

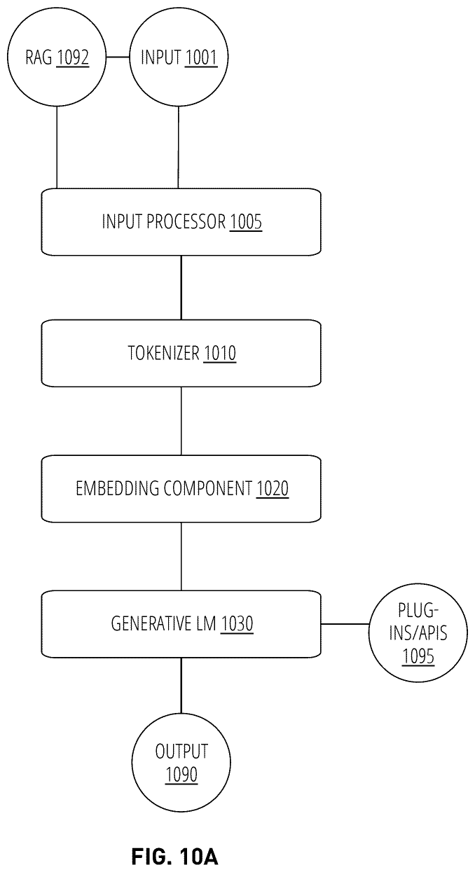

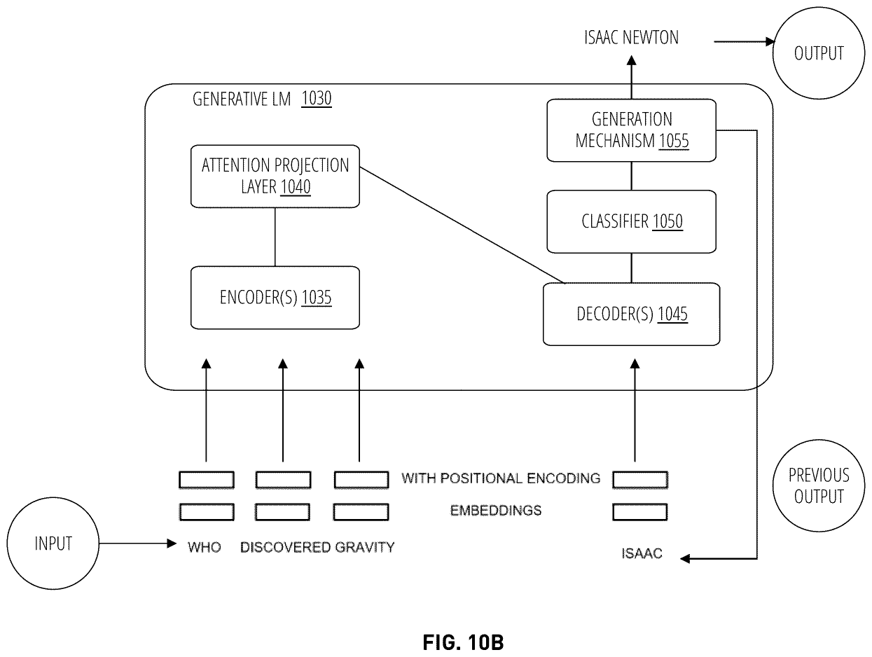

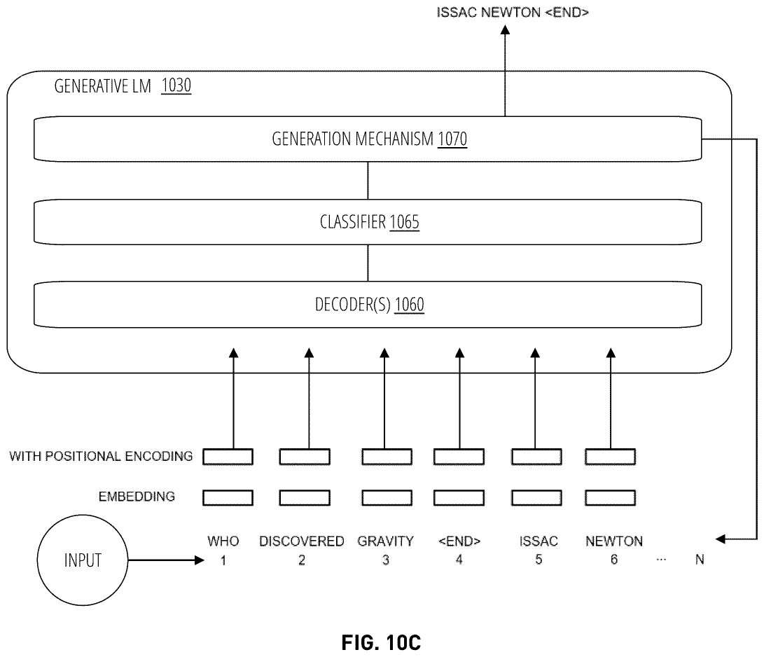

FIG. 10A is a block diagram of an example generative language model system 1300 suitable for use in implementing at least some embodiments of the present disclosure. In the example illustrated in FIG. 10A, the generative language model system 1300 includes a retrieval augmented generation (RAG) component 1092, an input processor 1005, a tokenizer 1010, an embedding component 1020, plug-ins/APIs 1095, and a generative language model (LM) 1030 (which may include an LLM, a SLM, a VLM, a multi-modal LM, etc.).

At a high level, the input processor 1005 may receive an input 1001 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 1030 (e.g., LLM/SLMs/VLM/MMLM/etc.). In some embodiments, the input 1001 includes plain text in the form of one or more sentences, paragraphs, and/or documents. Additionally, or alternatively, the input 1001 may include numerical sequences, precomputed embeddings (e.g., word or sentence embeddings), and/or structured data (e.g., in tabular formats, JSON, or XML). In some implementations in which the generative LM 1030 is capable of processing multi-modal inputs, the input 1001 may combine text (or may omit text) with image data, audio data, video data, design data, USD data, and/or other types of input data, such as but not limited to those described herein. Taking raw input text as an example, the input processor 1005 may prepare raw input text in various ways. For example, the input processor 1005 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1005 may remove stopwords to reduce noise and focus the generative LM 1030 on more meaningful content. The input processor 1005 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1092 (which may include one or more RAG models, and/or may be performed using the generative LM 1030 itself) may be used to retrieve additional information to be used as part of the input 1001 or prompt. RAG may be used to enhance the input to the LLM/SLMs/VLM/MMLM/etc. with external knowledge, so that answers to specific questions or queries or requests are more relevant-such as in a case where specific knowledge is required. The RAG component 1092 may fetch this additional information (e.g., grounding information, such as grounding text/image/video/audio/USD/CAD/etc.) from one or more external sources, which can then be fed to the LLM/SLMs/VLM/MMLM/etc. along with the prompt to improve accuracy of the responses or outputs of the model.

For example, in some embodiments, the input 1001 may be generated using the query or input to the model (e.g., a question, a request, etc.) in addition to data retrieved using the RAG component 1092. In some embodiments, the input processor 1005 may analyze the input 1001 and communicate with the RAG component 1092 (or the RAG component 1092 may be part of the input processor 1005, in embodiments) in order to identify relevant text and/or other data to provide to the generative LM 1030 as additional context or sources of information from which to identify the response, answer, or output 1090, generally. For example, where the input indicates that the user is interested in a desired tire pressure for a particular make and model of vehicle, the RAG component 1092 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1092 may retrieve a prior stored conversation history- or at least a summary thereof- and include the prior conversation history along with the current ask/request as part of the input 1001 to the generative LM 1030.

The RAG component 1092 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1092 and the embeddings of the chunks along with the embeddings of the query may be compared to identify the most similar/related embeddings to the query, which may be supplied to the generative LM 1030 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLMs/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLMs/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLMs/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1092 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1010 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1030 to understand morphological variations and handle out-of-vocabulary words more effectively. Character-based tokenization represents each character as a separate token, enabling the generative LM 1030 to process text at a fine-grained level. The choice of tokenization strategy may depend on factors such as the language being processed, the task at hand, and/or characteristics of the training dataset. As such, the tokenizer 1010 may convert the (e.g., processed) text into a structured format according to tokenization schema being implemented in the particular embodiment.

The embedding component 1020 may use any known embedding technique to transform discrete tokens into (e.g., dense, continuous vector) representations of semantic meaning. For example, the embedding component 1020 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1001 includes image data/video data/etc., the input processor 1001 may resize the data to a standard size compatible with format of a corresponding input channel and/or may normalize pixel values to a common range (e.g., 0 to 1) to ensure a consistent representation, and the embedding component 1020 may encode the image data using any known technique (e.g., using one or more convolutional neural networks (CNNs) to extract visual features). In some implementations in which the input 1001 includes audio data, the input processor 1001 may resample an audio file to a consistent sampling rate for uniform processing, and the embedding component 1020 may use any known technique to extract and encode audio features-such as in the form of a spectrogram (e.g., a mel-spectrogram). In some implementations in which the input 1001 includes video data, the input processor 1001 may extract frames or apply resizing to extracted frames, and the embedding component 1020 may extract features such as optical flow embeddings or video embeddings and/or may encode temporal information or sequences of frames. In some implementations in which the input 1001 includes multi-modal data, the embedding component 1020 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1030 and/or other components of the generative LM system 1300 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1020 may apply an encoded representation of the input 1001 to the generative LM 1030, and the generative LM 1030 may process the encoded representation of the input 1001 to generate an output 1090, which may include responsive text and/or other types of data.

As described herein, in some embodiments, the generative LM 1030 may be configured to access or use- or capable of accessing or using-plug-ins/APIs 1095 (which may include one or more plug-ins, application programming interfaces (APIs), databases, data stores, repositories, etc.). For example, for certain tasks or operations that the generative LM 1030 is not ideally suited for, the model may have instructions (e.g., as a result of training, and/or based on instructions in a given prompt, such as those retrieved using the RAG component 1092) to access one or more plug-ins/APIs 1095 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1095 to the plug-in/API 1095, the plug-in/API 1095 may process the information and return an answer to the generative LM 1030, and the generative LM 1030 may use the response to generate the output 1090. This process may be repeated—e.g., recursively—for any number of iterations and using any number of plug-ins/APIs 1095 until an output 1090 that addresses each ask/question/request/process/operation/etc. from the input 1001 can be generated. As such, the model(s) may not only rely on its own knowledge from training on a large dataset(s) and/or from data retrieved using the RAG component 1092, but also on the expertise or optimized nature of one or more external resources-such as the plug-ins/APIs 1095.

FIG. 10B is a block diagram of an example implementation in which the generative LM 1030 includes a transformer encoder-decoder. For example, assume input text such as “Who discovered gravity” is tokenized (e.g., by the tokenizer1010 of FIG. 10A) into tokens such as words, and each token is encoded (e.g., by the embedding component 1020 of FIG. 10A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1035 of the generative LM 1030.

In an example implementation, the encoder(s) 1035 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1040 may convert the context vector into attention vectors (keys and values) for the decoder(s) 1045.

In an example implementation, the decoder(s) 1045 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1035, in an example transformer architecture, each token (e.g., word) flows through a separate path in the decoder(s) 1045. During a first pass, the decoder(s) 1045, a classifier 1050, and a generation mechanism 1055 may generate a first token, and the generation mechanism 1055 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1045 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1035, except that it creates its queries from the layer below it and takes the keys and values (e.g., matrix) from the output of the encoder(s) 1035.

As such, the decoder(s) 1045 may output some decoded (e.g., vector) representation of the input being applied during a particular pass. The classifier 1050 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1055 may select or sample a word or token based on a corresponding predicted probability (e.g., select the word with the highest predicted probability) and append it to the output from a previous pass, generating each word or token sequentially. The generation mechanism 1055 may repeat the process, triggering successive decoder inputs and corresponding predictions until selecting or sampling a symbol or token that represents the end of the response, at which point, the generation mechanism 1055 may output the generated response.

FIG. 10C is a block diagram of an example implementation in which the generative LM 1030 includes a decoder-only transformer architecture. For example, the decoder(s) 1060 of FIG. 10C may operate similarly as the decoder(s) 1045 of FIG. 10B except each of the decoder(s) 1060 of FIG. 10C omits the encoder-decoder self-attention layer (since there is no encoder in this implementation). As such, the decoder(s) 1060 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1060. As with the decoder(s) 1045 of FIG. 10B, each token (e.g., word) may flow through a separate path in the decoder(s) 1060, and the decoder(s) 1060, a classifier 1065, and a generation mechanism 1070 may use auto-regression to sequentially generate one token at a time until predicting a symbol or token that represents the end of the response. The classifier 1065 and the generation mechanism 1070 may operate similarly as the classifier 1050 and the generation mechanism 1055 of FIG. 10B, with the generation mechanism 1070 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

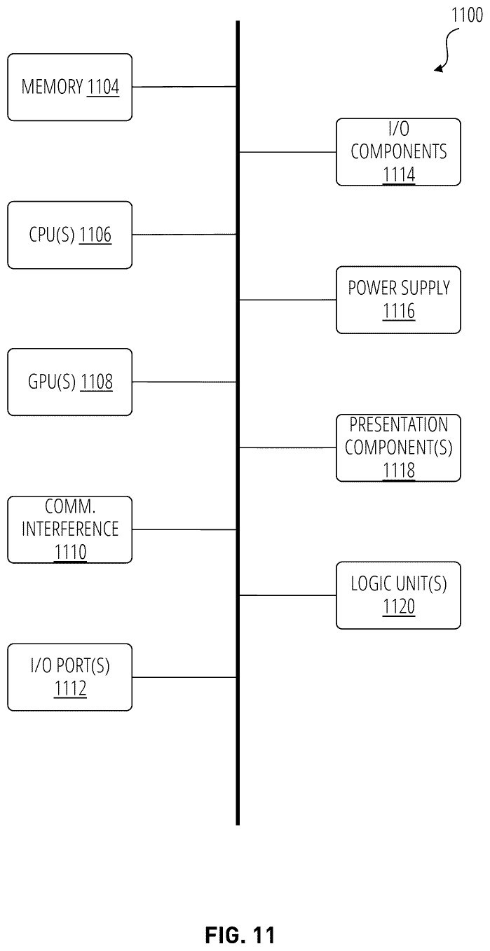

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1402 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). As such, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1402 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)-which may include one or more direct memory access (DMA) systems, one or more vision or vector processing units (VPUs), one or more pixel processing engines (PPEs), one or more decoupled accelerators (e.g., decoupled lookup table (DLUT) accelerators), etc., Vision Processing Units (VPUs), Optical Flow Accelerators (OFAs), Field Programmable Gate Arrays (FPGAs), Neuromorphic Chips, Quantum Processing Units (QPUs),

Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that allow the computing device 1100 to communicate with other computing devices via an electronic communication network, included wired and/or wireless communications. The communication interface 1110 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1402 directly to (e.g., a memory of) one or more GPU(s) 1108.

The I/O ports 1112 may allow the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that allow detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to allow the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other embodiment examples will be apparent to those of skill in the art upon reading and understanding the above description. Although the present disclosure describes specific examples, it will be recognized that the systems and methods of the present disclosure are not limited to the examples described herein but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing computing device (“CPU”) executes some of instructions while a graphics processing computing device (“GPU”) executes other instructions. In at least one embodiment, different components of a computer system have separate processors and different processors execute different sub sets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work overtime, such as tasks, threads, and intelligent agents. Also, each process may refer to multiple processes, for carrying out instructions in sequence or in parallel, continuously, or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
detecting, using at least one processor, an incident pertaining to operation of a plurality of resources of a data center based at least on event data from the plurality of resources;
providing, using the at least one processor and to a communication channel, a potential solution to address the detected incident, the potential solution being generated based at least on the event data and historical incident data associated with a plurality of historical incidents identified as being similar to the detected incident;
generating, using the at least one processor and during the operation of the plurality of resources, an updated potential solution to address the detected incident based at least on one or more exchanged communications on the communication channel, the event data, and the historical incident data; and
at least one of causing execution of the updated potential solution or sending data representative of the updated potential solution to one or more endpoints for use in executing the updated potential solution.

2. The method of claim 1, wherein the detecting the incident comprises:
monitoring, using the at least one processor, event data from the plurality of resources; and
identifying, using the at least one processor, the incident based at least on the event data indicating a resource of the plurality of resources requires intervention from one or more entities associated with the plurality of resources.

3. The method of claim 2, wherein the monitoring the event data from the plurality of resources further comprises:
receiving data from a resource of the plurality of resources;
processing the data at a data processor of a plurality of data processors based at least on a data type of the data; and
providing the data to a first data store of a plurality of data stores, the first data store being associated with the data type.

4. The method of claim 3, further comprising:
detecting, using the at least one processor, the incident based at least on a request of an entity on the communication channel to review the event data; and
identifying, using the at least one processor and one or more artificial intelligence (AI) agents, the incident based at least on the event data indicating the resource requires intervention from the one or more entities, wherein at least one agent of the one or more AI agents reviews data from a data store of the plurality of data stores.

5. The method of claim 4, wherein the identifying the incident comprises:
identifying the historical incident data from a historical incident data store, the identified historical incident data comprising similar incidents to the incident; and
determining that a relevancy confidence value of the historical incident data satisfies a threshold, the relevancy confidence value indicating a relevancy of the historical incident data to the incident.

6. The method of claim 4, further comprising:
generating, using the at least one processor, an event data store query based at least on the request; and
querying, using the at least one processor, one of a plurality of event data stores associated with the resource for event data usable for generating a response to the request.

7. The method of claim 1, further comprising, based at least on a partial resolution of the incident, updating, using the at least one processor, a historical incident data store with historical incident data corresponding to the incident.

8. The method of claim 1, wherein the providing the potential solution to address the detected incident comprises:
generating, using a language model, a message for one or more entities on the communication channel, the message including the updated potential solution.

9. The method of claim 1, further comprising providing the updated potential solution to at least one of one or more entities associated with the plurality of resources on the communication channel to ensure uninterrupted operation of the plurality of resources of the data center.

10. A system comprising:
one or more processors to:
detect, during operation of a plurality of resources of a data center, an incident pertaining to the operation of the plurality of resources based at least on event data from the plurality of resources;
generate, during the operation of the plurality of resources, an updated potential solution to address the incident based at least on one or more communications on a communication channel in response to a potential solution, the event data, and historical incident data associated with one or more historical incidents identified as similar to the incident; and
causing execution of the updated potential solution.

11. The system of claim 10, wherein to detect the incident the one or more processors are further to:
monitor event data from the plurality of resources; and
identify the incident based on the event data indicating a resource of the plurality of resources requires intervention from one or more entities associated with the plurality of resources to address the detected incident.

12. The system of claim 10, wherein the one or more processors are further to:
identify the incident based at least on the event data indicating a resource of the plurality of resources requires real time intervention from one or more entities associated with the plurality of resources to address the detected incident.

13. The system of claim 12, wherein, to identify the incident, the one or more processors are further to:
identify the historical incident data from a historical incident data store, the identified historical incident data including similar incidents to the incident; and
determine that a relevancy confidence value of the historical incident data satisfies a threshold, the relevancy confidence value indicating a relevancy of the historical incident data to the incident.

14. The system of claim 12, wherein the one or more processors are further to:
generate an event data store query based at least on a request; and
query one of a plurality of event data stores associated with the resource for data usable for generating a response to the request.

15. The system of claim 10, wherein the one or more processors are further to, based at least on a partial resolution of the incident, update a historical incident data store with historical incident data corresponding to the incident.

16. The system of claim 15, wherein the one or more processors are further to:
generate a summary comprising one or more of the incident, the one or more communications, the potential solution, or the updated potential solution.

17. The system of claim 10, wherein the causing execution of the updated potential solution includes:
generating, using a language model, a message for one or more entities on the communication channel, the message comprising the updated potential solution.

18. The system of claim 10, the one or more processors further to provide the updated potential solution to at least one of one or more entities on the communication channel to ensure uninterrupted operation of the plurality of resources of the data center.

19. One or more processors comprising:
processing circuitry to:
detect, during operation of a plurality of resources of a data center, an incident pertaining to the operation of the plurality of resources based on event data from the plurality of resources;
provide a potential solution to address the detected incident to one or more entities on a communication channel to address the detected incident;
generate, during the operation of the plurality of resources, an updated potential solution to address the incident based on one or more communications on the communication channel.

20. The one or more processors of claim 19, wherein to detect the incident, the one or more processors are further to:
monitor event data from the plurality of resources; and
identify the incident based at least on the event data indicating a resource of the plurality of resources requires real time intervention from at least one of the one or more entities.
